(19) United States
(12) Patent Application Publication
(10) Pub. No.: US 2009/0285997 A1
(43) Pub. Date: Nov. 19, 2009

(54) PAINTBRUSH AND EDGER HOLDER

(76) Inventor: Joseph Ludger Bartok, Thorold (CA)

Correspondence Address: CAREY, RODRIGUEZ, GREENBERG & PAUL LLP;ATTN: STEVEN M. GREENBERG, ESQ., 950 PENINSULA CORPORATE CIRCLE, SUITE 3020, BOCA RATON, FL, 33487, US

(21) Appl. No.: 12/472,822

(22) Filed: May 27, 2009

Related U.S. Application Data
(63) Continuation-in-part of application No. 11/935,755, filed on Nov. 6, 2007.
(60) Provisional application No. 60/861,266, filed on Nov. 28, 2006.

(51) Int. Cl. B05D 1/28; B65D 25/00

(52) U.S. Cl. 427/429; 220/736

(57) ABSTRACT

A holder can alternately hold an edger and a paintbrush, and comprises a main body having a support portion defining a generally planar support surface, and an attachment mechanism for removably securing the holder to a paint tray. When the holder is secured to the paint tray, the support surface is at an outwardly and upwardly extending angle to the paint tray, and extends inwardly past the side wall of the paint tray. A pair of opposed side walls run along sides of the support surface to confine liquid paint thereto so that the paint will run into the paint tray under gravity. One or more retention members retain the edger on the support surface when the edger is placed on the support surface, and the support surface has a magnet for retaining a paintbrush on the support surface when the paintbrush is placed on the support surface.

### CROSS-REFERENCE TO RELATED APPLICATIONS

This patent application claims the benefit under 35 U.S.C. § 120 as a continuation-in-part of U.S. patent application Ser. No. 11/935,755 filed Nov. 6, 2007 and entitled “PAINT TRAY”, which claims priority from U.S. Provisional Patent Application No. 60/861,266 filed Nov. 28, 2006 and entitled “PAINT TRAY”, the entire teachings of which are hereby incorporated by reference.

### FIELD OF INVENTION

This invention relates to painting equipment, and in particular to paintbrush and edger holders that can attach to paint containers.

### BACKGROUND OF THE INVENTION

Different kinds of paint trays have been used for many years, but there is still a need for a paint tray of relatively simple construction which can be placed on the floor or table and also can be attached to a ladder. It is therefore an object of this invention to provide a paint tray which meets such requirements.

Different kinds of paint trays, paintbrushes and edgers have also been used for many years. There is still a need for a paintbrush and edger holder of relatively simple construction which can be attached to a paint tray.

It is therefore an object of this invention to provide a paintbrush or edger holder which meets such requirements.

### SUMMARY OF THE INVENTION

In one aspect, the present invention is directed to a holder for removably alternately holding an edger and a paintbrush. The holder comprises a main body having a support portion defining a generally planar support surface, and an attachment mechanism on the main body for removably securing the holder to a paint tray so that the support surface is at an outwardly and upwardly extending angle to the paint tray with the support surface extending inwardly past a wall of the paint tray when the holder is secured to the paint tray. A pair of opposed side walls run along sides of the support surface to confine liquid paint to the support surface so that such liquid paint will run along the support surface and into the paint tray under gravity when the holder is secured to the paint tray. At least one retention member projects from the main body to retain the edger on the support surface when the edger is placed on the support surface, and the support surface includes a magnet for retaining a paintbrush having a securing band made from a ferromagnetic metal on the support surface when the paintbrush is placed on the support surface.

In one embodiment, the main body further comprises an attachment portion projecting downwardly from the support portion and the attachment mechanism comprises this attachment portion and at least one clip member mounted to the main body. The clip member is movable between an open position and a closed position relative to the attachment portion and is biased into the closed position.

In one embodiment, the magnet is received in a recess defined in the support surface so that an outer surface of the magnet is flush with the support surface.

In other aspects, the present invention is directed to methods for painting using the above-described holder.

### DESCRIPTION OF THE DRAWINGS

One embodiment of the invention will now be described, by way of example, with reference to the accompanying drawings, of which:

FIG. 1 is a perspective view of a paint tray in accordance with one embodiment of the invention mounted on a stepladder;

FIG. 1A shows an enlarged perspective view of one of the rear legs of the tray;

FIG. 2 is a perspective view of a portion of the tray showing a holder for an edger attached thereto;

FIG. 3 is similar view to FIG. 2 but shows a holder for a paintbrush attached to the tray;

FIG. 4 is a perspective view of a paintbrush and edger holder attached to a sidewall of a paint tray;

FIG. 5 is a perspective view of a paintbrush and edger holder attached to a sidewall of a paint tray with a paintbrush removably attached to the holder;

FIG. 5A is a side view of a paintbrush and edger holder attached to a side wall of a paint tray;

FIG. 6 is a rear view of a paintbrush and edger holder;

FIG. 7 is a perspective view of a paintbrush and edger holder attached to a sidewall of a paint tray with an edger removably retained by the holder;

FIG. 8 is a flow chart showing a first embodiment of a method of painting according to an aspect of the present invention; and

FIG. 9 is a flow chart showing a second embodiment of a method of painting according to an aspect of the present invention.

### DESCRIPTION OF PREFERRED EMBODIMENTS

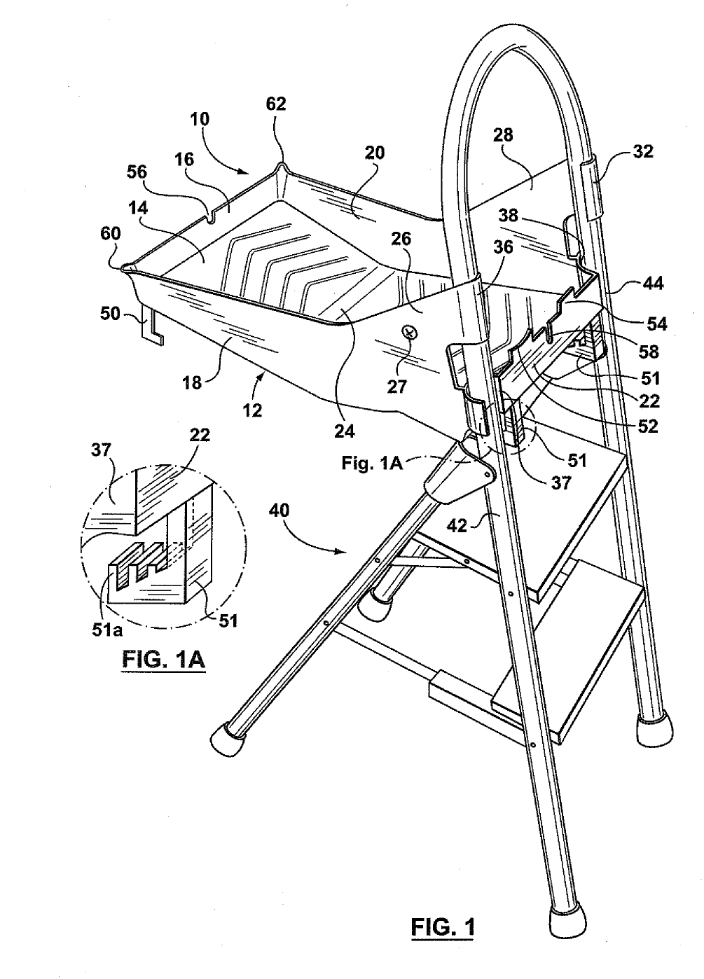

Referring first to FIG. 1 and FIG. 1A, a paint tray 10 which may be of suitable plastic material has a tray-like main body 12 with a rectangular base 14 surrounded by a front wall 16, side walls 18, 20 and a rear wall 22 to define a paint cavity for retaining paint therein. The base 14 slopes downwardly from both the front wall 16 and the rear wall 22 to a lowermost level halfway along the tray.

Each side wall 18, 20 has an upwardly and rearwardly extending attachment portion 26, 28 adjacent its rear end, and each attachment portion 26, 28 has a curved end portion 30, 32. Each curved end portion 30, 32 is engagable with the laterally-spaced uprights 42, 44 of a step-ladder 40. The attachment portions 26, 28 also have recesses 37, 38 below the curved end portions 30, 32 and adjacent the rear wall 22 which engage the uprights 42, 44, thereby securing the tray 10 to the ladder 40 as shown in the drawings. The recesses 37, 38 also enable the rear wall 22 to be positioned between the ladder uprights 42, 44. Thus, the step-ladder 40 can easily be moved from one location to another with the paint tray 10 attached thereto.

The front end of the tray 10 has legs 50 and the rear end of the tray has a pair of laterally spaced legs 51 to enable the tray to be placed on the ground in a level condition when desired, for example on the floor or on a table top. As shown in FIG. 1A, the rear legs 51 are hook-shaped with upwardly extending fingers 51a to enable the tray 10 to be secured to the rung of a long ladder instead of to a step-ladder. Also, attachment portion 26 is provided with a cloth holder in the form of an aperture 27.

The upper edge of the rear wall 22 may have a large part-circular recess 52 and a small part-circular recess 54 to enable a large or small paint roller to be pulled across the recess upper edge to wipe excess paint from the roller, which paint then falls back into the tray. Also, the front and rear walls 16, 22 may have a central notch 56, 58 in their upper edges into which a part of the paint roller handle may be placed to retain a paint roller in a suitable position in the tray. Further, the front corners 60, 62 of the tray 10 may be shaped to function as pouring spouts to empty the tray.

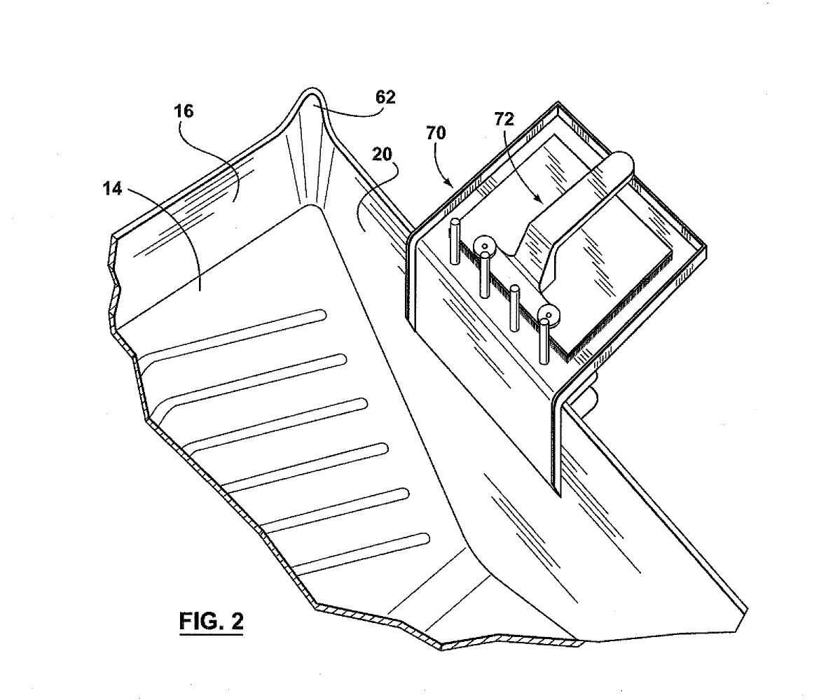

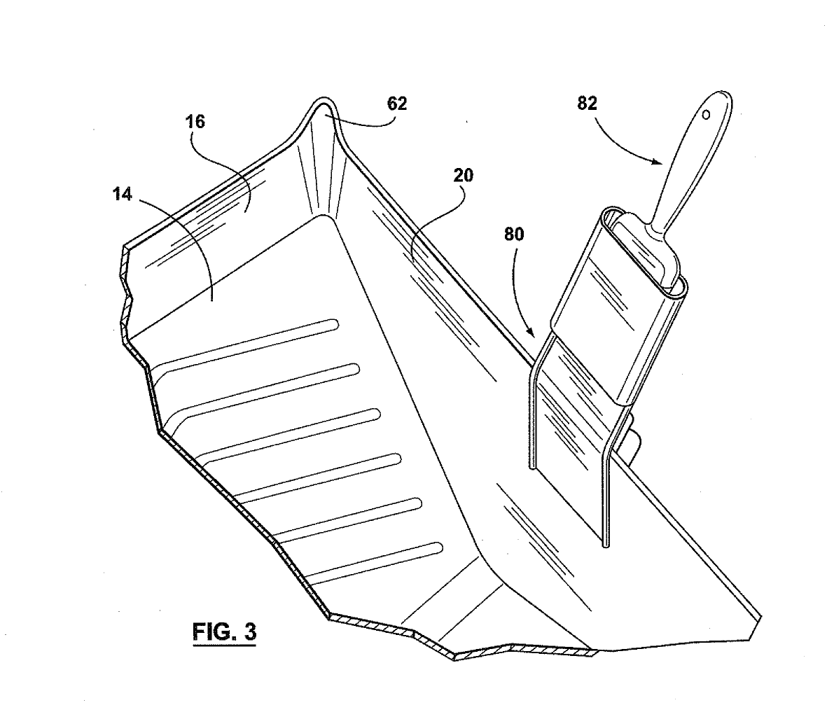

FIG. 2 shows how a holder 70 for an edger 72 may be detachably secured to a side wall of the tray, and FIG. 3 shows how a holder 80 for a paintbrush 82 may be detachably secured to a side wall of the tray in such a manner that paint dripping from the brush 82 runs into the tray.

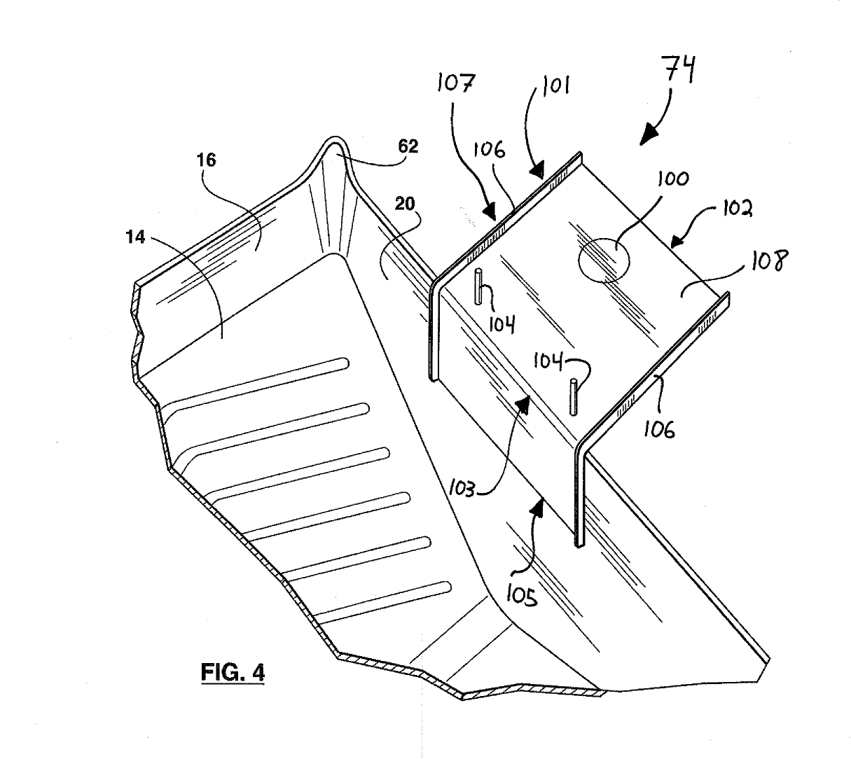

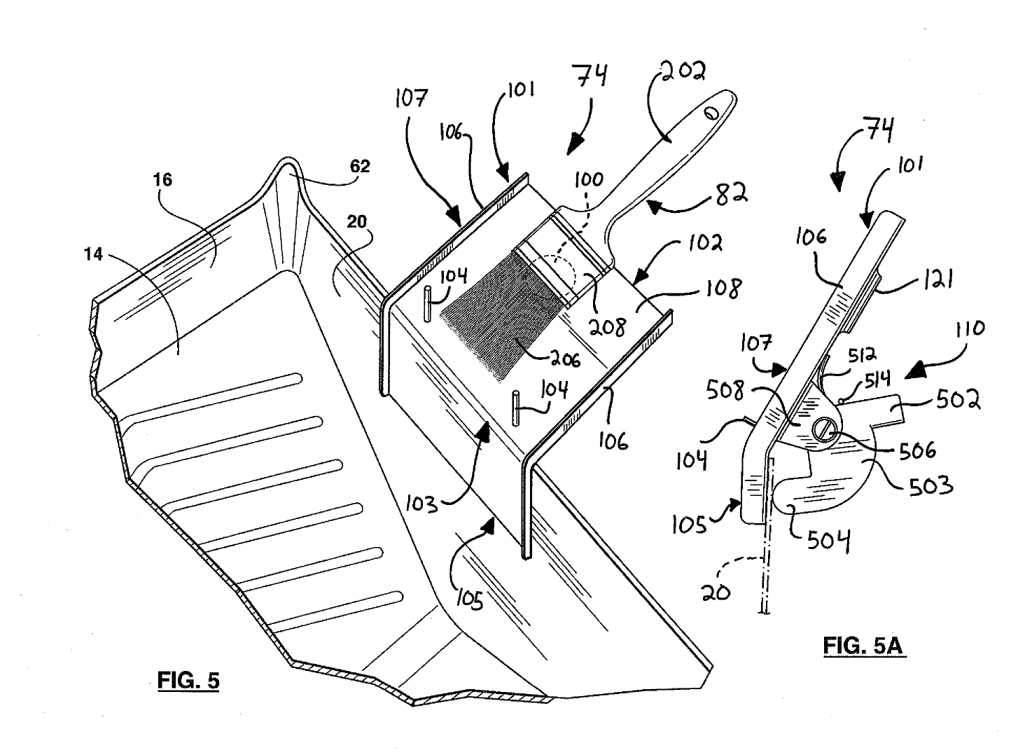

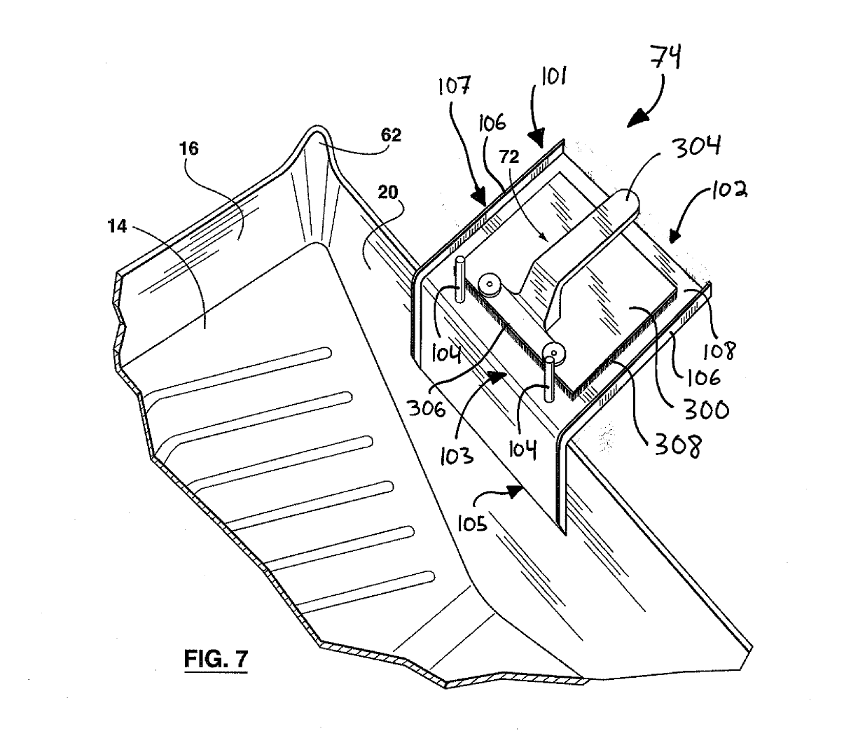

FIG. 4 shows an exemplary holder 74 for removably alternately holding an edger 72 (FIG. 7) and/or a paintbrush 82 (FIG. 5), secured to the paint tray 10. The holder 74 has a unitary main body 101 having a support portion 107 defining a generally planar support surface 108 and an attachment portion 105 extending downwardly from the support portion 107. When the holder 74 is attached to the paint tray 10, the support surface 108 extends between a distal end 102 of the support portion 107 furthest from the paint tray 10 and a curved proximal end 103 of the support portion 107. The curved proximal end 103 is immediately adjacent the attachment portion 105, and the proximal end 103 of the support portion 107 is defined by a bend in the main body 101 which divides the main body 101 into the support portion 107 and the attachment portion 105.

A pair of opposed lips or side walls 106 run along the sides of the support surface 108 to confine liquid paint to the support surface 108 so that such liquid paint will run along the support surface 108 and into the paint tray 10 under gravity when the holder 74 is secured to the paint tray 10. Two cylindrical retention members 104 project upwardly from the main body 101, and in particular from the support portion 107, near the curved proximal end 103, to retain an edger 72 on the support surface 108, as shown in FIG. 7. Optionally, more than two retention members may be used, or a single retention member may be used and may cooperate with the side walls 106 to retain the edger 72.

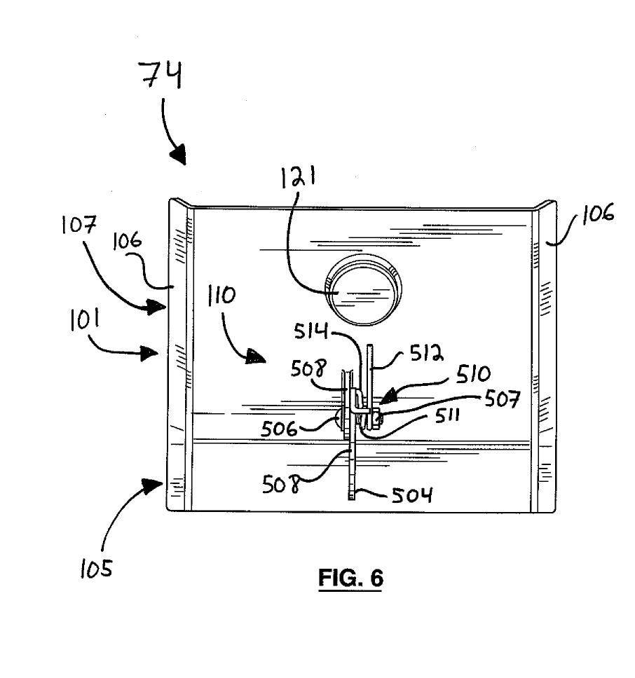

A substantially flat circular magnet 100 is secured on the support surface 108 near the distal end 102 of the holder 74. The top surface of the magnet 100 is preferably flush with the support surface 108 of the holder 74, and in the illustrated embodiment, is received within a correspondingly sized recess 121 (see FIGS. 5A and 6) or aperture in the main body 101. While the magnet 100 in the exemplary embodiment is a circular magnet, in other embodiments other shapes of magnet, such as a rectangular magnet, may also be used without departing from the scope of the present invention.

Referring now to FIGS. 5A and 6, an attachment mechanism 110 is located on the underside of the main body 101, opposite the support surface 108 of the holder 74, and comprises the attachment portion 105, as well as a mount 508, a clip member 503, and a biasing member 510. The mount 508 projects from the underside of the support portion 107, and the clip member 503 is rotatably mounted to the mount 508 by a bolt 506 passing through apertures in the mount 508 and clip member 503, together with a nut 507 so that the clip member 503 is movable between an open position and a closed position relative to the attachment portion 105. More particularly, a gripping end 504 of the clip member 503 is movable into and out of engagement with the underside of the attachment portion 105 of the holder 74, thereby defining open and closed positions for the clip member 503 and hence the attachment mechanism 110. The clip member 503 is biased into the closed position by a biasing member 510 in the form of a coil spring 510 having a main coil 511 which surrounds the bolt 506, a first arm 512 which engages the underside of the support portion 107 of the main body 101, and a second arm 514 which engages an upper surface of the clip member 503 adjacent a handle end 502 thereof. In other embodiments, a pivot pin or other axle arrangement may be used instead of the bolt 506 and nut 507, and the main coil 511 of the spring 510 would surround such pivot pin or axle.

The holder 74 can be mounted on the paint tray 10 by rotating the clip member 503 relative to the mount 508 so that the gripping end 504 of the clip member 503 moves away from the underside of the attachment portion 105, placing the side wall 20 of the paint tray 10 between the attachment portion 105 and the gripping end 504 of the clip 503, and allowing the clip member 503 to rotate under urging from the spring 510 until the side wall 20 is sandwiched between the attachment portion 105 of the holder 74 and the gripping end 504 of the clip 503, as shown in FIG. 5A.

As best seen in FIG. 5A, when the holder 74 is secured to the side wall 20 of the paint tray 10 by the attachment mechanism 110, the support portion 107 and hence the support surface 108 (not shown in FIG. 5A) is angled so that it is inclined towards the base 14 of the paint tray 10. In particular, the support portion 107 and therefore the support surface 108 is at an outwardly and upwardly extending angle to the paint tray 10, with the support portion 107 and therefore the support surface 108 extending inwardly past the side wall 20 of the paint tray 10.

To remove the holder 74 from the paint tray 10, the clip member 503 is rotated so that its gripping end 504 moves away from the underside of the attachment portion 105, allowing the holder 74 to be moved up and away from the side wall 20.

The attachment mechanism 110 can be used to secure the holder 74 to any wall of the paint tray 10, not only the side wall 20, and can also be used to secure the holder 74 to the circular rim of a suitably sized cylindrical paint container.

FIG. 5 shows a paintbrush 82 retained by the holder 74. The paintbrush 82 has a handle 202 opposite a set of bristles 206. As is conventional, the bristles 206 are secured to the handle 202 by a securing band 208 made from a ferromagnetic metal, which enables the paintbrush 82 to be retained on the support surface 108 by the magnet 100. The strength of the magnet 100 is sufficient to retain the paintbrush 82 on the support surface 108, while still permitting the paintbrush 82 to be easily removed by a user.

In ordinary use, the paintbrush 82 is retained on the holder 74 by the magnet 100 with the bristles 206 extending toward the base 14 of the paint tray 10. Because the support surface 108 of the holder 74 is inclined towards the base 14 of the paint tray 10, excess paint left on the bristles 206 can drip back into the paint tray 10. The handle 202 of the paintbrush 82 may extend beyond the distal end 102 of the holder 74 to permit it to be easily grasped by a user.

Referring now to FIG. 7, the holder 74 is shown retaining an edger 72. The edger 72 is generally rectangular in shape with a straight front edge 306, and a handle 304 extends from the top side 300 of the edger 72. The underside of the edger 72 has bristles 308. The edger 72 may be fabricated out of plastic, wood or other suitable material and need not have any metallic portions in order to be retained by the holder 74, as the front edge 306 of the edger 72 rests against the cylindrical retention members 104. Because the support surface 108 of the holder 74 is inclined towards the paint tray 10, the edger 72 will slide along the support surface under gravity until the front edge 306 abuts the retention members 104, which are positioned to inhibit the edger 72 from sliding into the paint tray 10.

It is to be appreciated that the retention members 104 may cooperate with the opposing side walls 106 to retain the edger 72 when the edger 72 is placed on the support surface 108. Moreover, other retention member arrangements may be used to retain the edger 72, without departing from the scope of the present invention.

In operation, the paintbrush 82 may be dipped into a volume of paint disposed in the paint cavity of the paint tray 10 and used to paint a surface. The paintbrush 82 may then be placed (or replaced) on the support surface 108 and retained thereon by the magnet 100 (see FIG. 5), so that excess paint drips off the bristles 206 of the paintbrush 82, down the support surface 108 and attachment portion 105 and back into the paint tray 10. Similarly, the edger 72 can be used to apply paint to a surface and the edger 72 can then be placed (or replaced) on the support surface 108 of the holder 74 and retained by the retention members 104 to allow excess paint to drip off the edger 72 and back into the paint tray 10.

An edger 72 and paintbrush 82 can be used interchangeably with one another by way of the holder 74, so that when the paintbrush 82 is being used to apply paint to a surface, the edger 72 is retained in the holder 74, and vice versa. By way of example, an edger 72 may be retained in the holder 74 while the paintbrush 82 is being used to apply paint to a surface. The paintbrush 82 may then be exchanged with the edger 72 such that the paintbrush 82 is retained in the holder 74 and the edger 72 is used to apply paint to a surface. The edger 72 may similarly be exchanged with the paintbrush 82 in the holder 74.

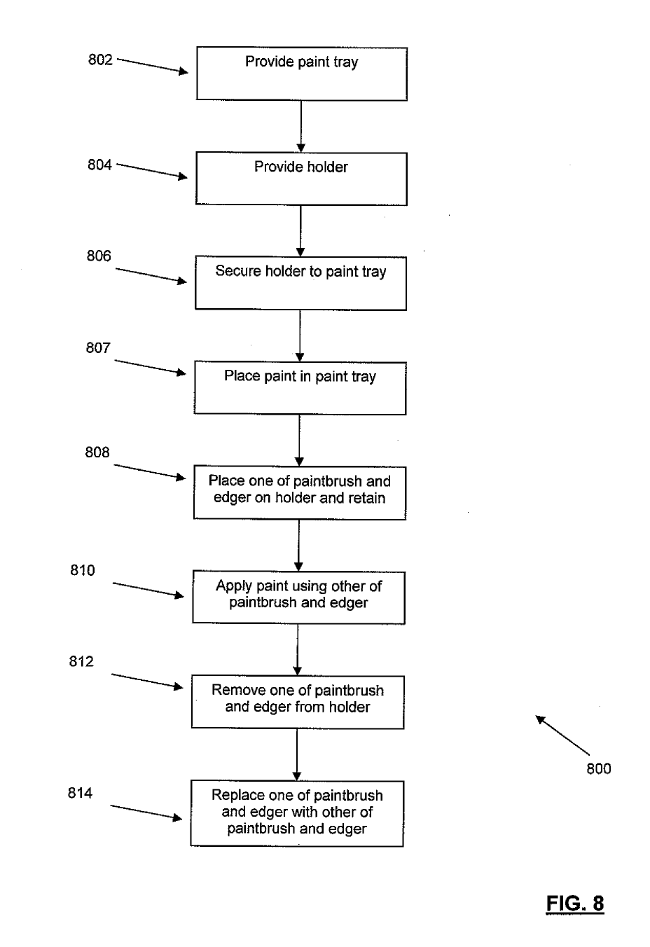

Referring now to FIG. 8, an exemplary method for painting using a holder according to an aspect of the present invention, such as the holder 74, is shown generally at 800. At step 802, a paint container having a paint cavity (such as the paint tray 10) is provided, and at step 804, a holder according to an aspect of the present invention, such as the holder 74, is provided. At step 806, the holder is secured to the paint tray, and at step 807, liquid paint is placed in the paint cavity of the paint tray. Then, at step 808, one of a paintbrush (such as the paintbrush 82) and an edger (such as the edger 72) is placed on the holder and retained thereon, and at step 810, the other of the paintbrush and the edger is used to apply paint from the paint tray to an object. At step 812, the one of the paintbrush and the edger is removed from the holder, and at step 814 is replaced with the other of the paintbrush and the edger.

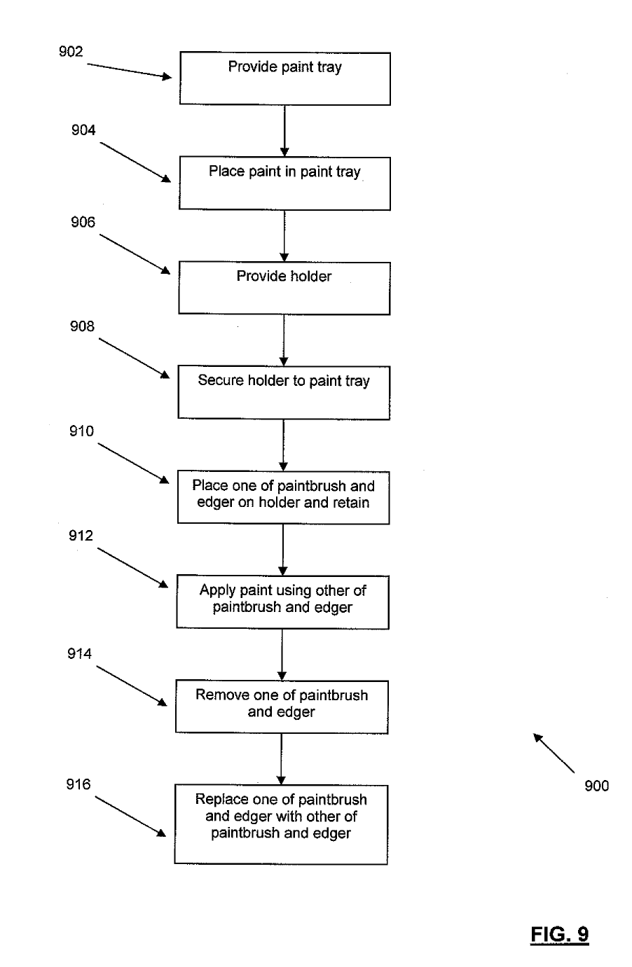

With reference now to FIG. 9, an alternate method for painting using a holder according to an aspect of the present invention, such as the holder 74, is shown generally at 900. At step 902, a paint tray (such as the paint tray 10) having a paint cavity is provided and, at step 904, liquid paint is then placed in the paint cavity. At step 906, a holder according to an aspect of the present invention, such as the holder 74, is provided and at step 908 (i.e. after the liquid paint is disposed in the cavity of the paint tray 10) the holder is secured to the paint tray. At step 910, one of a paintbrush (e.g. paintbrush 82) and an edger (e.g. edger 72) is selectively placed on and retained by the holder, and at step 912 paint is applied to an object using the other of the paintbrush and the edger. At step 914, the one of the paintbrush and the edger is removed from the holder, and at step 916 is replaced with the other of the paintbrush and the edger.

Reference has been made herein to paint trays. Neither the paint tray 10 shown herein, nor any other paint tray, form part of the present invention, and any references to paint trays in the claims are intended solely to define attributes of the invention and not to define any paint trays as a component of any embodiment of any aspect of the invention. Rather, paint tray 10 is merely an exemplary paint tray representative of paint trays in association with which embodiments of aspects of the present invention may be used. In addition, the edger 72 and paintbrush 82 described herein are merely exemplary, and are not intended to limit the scope of the invention as claimed.

The advantages of the invention will now be readily apparent to a person skilled in the art from the foregoing description of preferred embodiments. Other advantages and embodiments will also now be readily apparent, the scope of the invention being defined in the appended claims.

What is claimed is:

1. A holder for removably alternately holding an edger and a paintbrush, the holder comprising:
a main body having a support portion defining a generally planar support surface;
an attachment mechanism on the main body for removably securing the holder to a paint tray so that the support surface is at an outwardly and upwardly extending angle to the paint tray with the support surface extending inwardly past a wall of the paint tray when the holder is secured to the paint tray;
a pair of opposed side walls running along sides of the support surface to confine liquid paint to the support surface so that such liquid paint will run along the support surface and into the paint tray under gravity when the holder is secured to the paint tray;
at least one retention member projecting from the main body to retain the edger on the support surface when the edger is placed on the support surface; and
a magnet on the support surface for retaining a paintbrush having a securing band made from a ferromagnetic metal on the support surface when the paintbrush is placed on the support surface.

2. The holder of claim 1, wherein the main body further comprises an attachment portion projecting downwardly from the support portion and the attachment mechanism comprises:
the attachment portion; and
at least one clip member mounted to the main body, the clip member being movable between an open position and a closed position relative to the attachment portion and being biased into the closed position.

3. The holder of claim 1, wherein the magnet is received in a recess defined in the support surface so that an outer surface of the magnet is flush with the support surface.

4. A method of painting, comprising:
providing a paint tray having a paint cavity;
providing a holder, the holder comprising:
a main body having a support portion defining a generally planar support surface;
an attachment mechanism on the main body for removably securing the holder to a paint tray so that the support surface is at an outwardly and upwardly extending angle to the paint tray with the support surface extending inwardly past a wall of the paint tray when the holder is secured to the paint tray;
a pair of opposed side walls running along sides of the support surface to confine liquid paint to the support surface so that such liquid paint will run along the support surface and into the paint tray under gravity when the holder is secured to the paint tray;
at least one retention member projecting from the main body to retain the edger on the support surface when the edger is placed on the support surface; and
a magnet on the support surface for retaining a paintbrush having a securing band made from a ferromagnetic metal on the support surface when the paintbrush is placed on the support surface.
securing the holder to the paint tray;
selectively retaining one of the paintbrush and the edger on the holder;
applying paint from the paint tray to an object using the other of the paintbrush and the edger;
removing the one of the paintbrush and the edger from the holder;
replacing the one of the paintbrush and the edger with the other of the paintbrush and the edger in the holder.

5. The method of claim 5, wherein liquid paint is disposed in the paint cavity of the paint tray before securing the holder to the paint tray.

6. The method of claim 5, wherein liquid paint is added to the paint cavity of the paint tray after securing the holder to the paint tray.
